(19) United States
(12) Patent Application Publication
(10) Pub. No.: US 2024/0025164 A1
(43) Pub. Date: Jan. 25, 2024

(54) MULTILAYER STRUCTURES THAT INCLUDE ORIENTED FILMS AND SEALANT LAYERS

(71) Applicant: Dow Global Technologies LLC, Midland, MI (US)

(72) Inventor: Eva-Maria Kupsch, Waedenswil (CH)

(73) Assignee: Dow Global Technologies LLC, Midland, MI (US)

(21) Appl. No.: 18/256,498

(22) PCT Filed: Dec. 8, 2021
(86) PCT No.: PCT/US2021/062370

§ 371 Date: Jun. 8, 2023

Related U.S. Application Data
(60) Provisional application No. 63/124,300, filed on Dec. 11, 2020.

(51) Int. Cl. B32B 27/32; B32B 27/08; B32B 7/12; B32B 7/02

(52) U.S. Cl. CPC B32B 27/32; B32B 27/08; B32B 7/12; B32B 7/02; B32B 2307/72; B32B 2270/00; B32B 2307/31; B32B 2250/242; B32B 2553/00; B32B 2307/514

(57) ABSTRACT

According to one or more embodiments presently disclosed herein, a multilayer structure may include an oriented film and a sealant layer. The oriented film may include at least 90% by weight polyethylene. The sealant layer may include from 15 wt. % to 40 wt. % of a low density polyethylene based on the total weight of the sealant layer. The sealant layer may further include (a) from 60 wt. % to 85 wt. % of an ethylene-based elastomer based on the total weight of the sealant layer, or (b) from 60 wt. % to 85 wt. % of a propylene-based plastomer based on the total weight of the sealant layer.

### CROSS REFERENCE

This application claims priority to U.S. Provisional Application 63/124,300, filed Dec. 11, 2020, the contents of which are hereby incorporated by reference in their entirety.

### TECHNICAL FIELD

The present disclosure generally relates to multilayer structures and, more specifically, to polyolefin multilayer structures such as those used in consumer packaging.

### BACKGROUND

Many types of flexible and semi-rigid packages created to protect food, beverages, other liquids, personal care, and other consumer products have been manufactured using polyolefinic multilayer structures. Such structures may be sealed under heat, as is widely understood. Commonly, sealant layers are utilized in the packaging to seal multilayer structures together under increased temperature. It would be desirable to have alternative multilayer structures that can be used in packages and can provide one or more benefits.

### SUMMARY

Many multilayer structures, such as films, for use in packaging are sealed by utilizing heated seal bars, which bond two films to one another. Sealant layers may be provided as part of the multilayer structure which thermally melts to form a sealing bond. Oriented polyethylene films, such a machine direction oriented films and biaxially oriented films, have become more common and are desirable for use in some packaging applications. Embodiments of the present disclosure provide a sealant layer that includes a combination of low density polyethylene and an ethylene-based elastomer, or a combination of low density polyethylene and propylene-based plastomer. Such sealant layers may provide a seal at reduced sealing temperatures as compared to conventional sealant layers. This can be particularly advantageous for use with oriented films comprising at least 90% by weight of polyethylene, as such films have a lower melting point as compared with polypropylene or polyethylene terephthalate films often utilized for packaging materials. By facilitating sealing at lower temperatures, the sealant layer, when utilized with oriented film having at least 90% by weight of polyethylene, can provide good seal strength while minimizing or avoiding degradation or other damage to the oriented film. Additionally, the sealant layers disclosed herein, in one or more embodiments, may allow for improved processing (e.g., increased processing speeds at reduced motor loads). These, and other advantages, may be exhibited by the presently disclosed multilayer structures, according to one or more embodiments described herein.

According to one or more embodiments of the present disclosure, a multilayer structure may comprise an oriented film and a sealant layer. The oriented film may comprise at least 90% by weight polyethylene. The sealant layer may be on the oriented film. The sealant layer may comprise from 15 wt. % to 40 wt. % of a low density polyethylene based on the total weight of the sealant layer. The sealant layer may further comprise from 60 wt. % to 85 wt. % of an ethylene-based elastomer based on the total weight of the sealant layer. The ethylene-based elastomer of the sealant layer may have a density of from 0.870 g/cm³ to 0.911 g/cm³ and a melt index (12) of at least 3 g/10 minutes.

According to one or more additional embodiments of the present disclosure, a multilayer structure may comprise an oriented film and a sealant layer. The oriented film may comprising at least 90% by weight polyethylene. The sealant layer may be on the oriented film. The sealant layer may comprise from 15 wt. % to 40 wt. % of a low density polyethylene based on the total weight of the sealant layer. The sealant layer may further comprise from 60 wt. % to 85 wt. % of a propylene-based plastomer based on the total weight of the sealant layer. The propylene-based plastomer may have a density of from 0.890 g/cm³ or less and a melt flow rate (at 230° C. and 2.16 kg) of at least 8 g/10 minutes.

These and other embodiments are described in more detail in the Detailed Description. It is to be understood that both the foregoing general description and the following detailed description present embodiments of the technology, and are intended to provide an overview or framework for understanding the nature and character of the technology as it is claimed. The accompanying drawings are included to provide a further understanding of the technology, and are incorporated into and constitute a part of this specification. The drawings illustrate various embodiments and together with the description serve to explain the principles and operations of the technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and wherein:

FIG. 1 graphically depicts seal strength of example embodiments, according to one or more embodiments of the present disclosure; and

FIG. 2 graphically depicts hot tack strength of example embodiments, according to one or more embodiments of the present disclosure.

### DETAILED DESCRIPTION

Reference will now be made in greater detail to various embodiments, which are examples of the claimed subject matter. It should be understood that the features of the multilayered structures described in the detailed description should not be understood as limiting on the claimed embodiments unless explicitly described as such.

Described herein, according to one or more embodiments, are multilayered structures that include oriented films and sealant layers. In some embodiments, the sealant layers may include low density polyethylene and propylene-based plastomer. In additional embodiments, the sealant layer may comprise low density polyethylene and ethylene-based elastomer. As described herein, a “multilayer structure” means any structure having more than one layer. For example, the multilayer structure (for example, a film) may have two, three, four, five or more layers. A multilayer structure may be described as having the layers designated with letters. For example, a three layer structure having a core layer B, and two external layers A and C may be designated as A/B/C. Likewise, a structure having two core layers B and C and two external layers A and D would be designated A/B/C/D.

According to one or more embodiments, the multilayer structures may comprise an oriented film. As described herein, “oriented” films are those that are formed by stretching of the film in any direction. Embodiments of oriented films include machine direction oriented films and biaxially oriented films.

According to one or more embodiments, the multilayer structures may comprise a machine direction oriented film. As described herein, “machine direction oriented” films are those that are formed by uniaxially stretching of the film in the machine direction. For example, the film may be heated and uniaxially stretched in the machine direction over a series of rollers. As used herein, the terms “machine direction” means the length of a film in the direction in which it is produced. Machine direction oriented films may exhibit improved tensile properties as compared with those not subjected to the machine direction orientation procedure.

According to additional embodiments, multilayer structures may comprise a biaxially oriented film. As described herein, “biaxially oriented” films are those that are formed by biaxial stretching of the film in the machine direction and in the cross or transverse direction to improve physical and/or barrier properties. For example, the film may be heated and biaxially stretched in the machine and cross direction over a series of rollers. As used herein, the terms “machine direction” means the length of a film in the direction in which it is produced. The terms “cross direction” or “transverse direction” or “cross directional” mean the width of film, i.e. a direction generally perpendicular to the machine direction. Biaxially oriented films may exhibit improved tensile properties as compared with those not subjected to the biaxial orientation procedure.

A “film,” as described herein, generally includes any continuous layer of polyolefin-including material which generally has a large length to width ratio. In one or more embodiments, a film may comprise one or more olefin-based polymers. The term, “olefin-based polymer,” “olefinic polymer,” and “polyolefin,” as used herein, refer to a polymer that comprises, in polymerized form, a majority amount of olefin monomer, for example, ethylene or propylene (based on the weight of the polymer) and, optionally, may comprise one or more comonomers. The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The films described herein may be a multilayer film which contains more than one layer.

In one or more embodiments, the oriented film may comprise at least 90% by weight polyethylene. In additional embodiments, the oriented film may comprise at least 95% by weight, at least 98% by weight, at least 99% by weight, or even at least 99.5% by weight polyethylene. It should be understood that the oriented film may be, for example, a monolayer of blended polymers where at least 90% by weight is polyethylene, or may be multilayered, where some layers are not polyethylene, but the combination of layers comprise at least 90% by weight of polyethylene. In one or more embodiments, the material of the oriented film most near the sealant layer may comprise polyethylene.

As described herein, “polyethylene” or an “ethylene-based polymer” shall mean polymers comprising greater than 50% by mole of units derived from ethylene monomer. This includes ethylene-based homopolymers or copolymers (meaning units derived from two or more comonomers). Forms of polyethylene include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

Additionally, as described herein, the term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see, for example, U.S. Pat. No. 4,599,392, which is hereby incorporated by reference). LDPE resins typically have a density in the range of 0.916 to 0.940 g/cm.

The term “LLDPE”, as described herein, may include resins made using Ziegler-Natta catalyst systems as well as resin made using single-site catalysts, including, but not limited to, bis-metallocene catalysts (sometimes referred to as “m-LLDPE”), phosphinimine, and constrained geometry catalysts; and resin made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236; 5,278,272; 5,582,923; and 5,733,155; the homogeneously branched ethylene polymers such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art. The LLDPE resins can be made via gas-phase, solution-phase, or slurry polymerization or any combination thereof, using any type of reactor or reactor configuration known in the art.

The term “ULDPE” is defined as a polyethylene-based copolymer having a density in the range of 0.895 to 0.915 g/cc.

The term “MDPE” refers to polyethylenes having densities from 0.926 to 0.935 g/cc. “MDPE” is typically made using chromium or Ziegler-Natta catalysts or using single-site catalysts including, but not limited to, bis-metallocene catalysts and constrained geometry catalysts.

The term “MDPE” refers to polyethylenes having densities from 0.926 to 0.935 g/cc. “MDPE” is typically made using chromium or Ziegler-Natta catalysts or using single-site catalysts including, but not limited to, bis-metallocene catalysts and constrained geometry catalysts.

Additionally, as described herein, the term “HDPE” refers to polyethylenes having densities of about 0.940 g/cm or greater, which are generally prepared with Ziegler-Natta catalysts, chrome catalysts or even metallocene catalysts.

According to one or more embodiments, the oriented film may have a melting point of less than or equal to 150° C., such as less than or equal to 145° C., or even less than or equal to 140° C., and, for example, at least 120° C. This is in contrast to other films, which may have higher melting points. For example, polypropylene films may have melting points of greater than 150° C., and polyethylene terephthalate films may have melting points of greater than 250° C.

It should be understood that oriented films described herein are not particularly limited by production method or source. Those skilled in the art may generally be familiar with oriented films, many of which are commercially available. As would be understood by those skilled in the art, a particular oriented film may be chosen based on the intended use of the multilayer structure.

It should be understood that any of the layers of the film may further comprise one or more additives as known to those of skill in the art such as, for example, plasticizers, stabilizers including viscosity stabilizers, hydrolytic stabilizers, primary and secondary antioxidants, ultraviolet light absorbers, anti-static agents, dyes, pigments or other coloring agents, inorganic fillers, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, or combinations of two or more thereof. Inorganic fillers, such as calcium carbonate, and the like can also be incorporated into one or more of the first layer, the second layer, the third layer, and combinations thereof. In some embodiments, the skin layers, the subskin layers, the tie layers, the barrier layer, and combinations may each include up to 5 weight percent of such additional additives based on the total weight of the respective layer. All individual values and subranges from 0 wt. % to 5 wt. % are included and disclosed herein; for example, the total amount of additives in any layer can be from 0.5 wt. % to 5 wt. %, from 0.5 wt. % to 4 wt. %, from 0.5 wt. % to 3 wt. %, from 0.5 wt. % to 2 wt. %, from 0.5 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % based on the total weight of the respective layer. The incorporation of the additives can be carried out by any known process such as, for example, by dry blending, by extruding a mixture of the various constituents, by the conventional master batch technique, or the like.

The multilayer structures of the present disclosure can have a variety of thicknesses. The thickness of the multilayer structures may depend on a number of factors including, for example, the number of layers in the multilayer structures, the composition of the layers in the multilayer structures, the desired properties of the multilayer structures, the desired end-use application of the multilayer structures, the manufacturing process of the multilayer structures, and others. In embodiments, the multilayer structures may have a thickness of less than 205 micrometers (μm or microns). In embodiments, the multilayer structure may have a thickness of from 15 μm to 205 μm, from 20 μm to 180 μm, from 15 μm to 180 μm, from 15 μm to 160 μm, from 15 μm to 140 μm, from 15 μm to 120 μm, from 15 μm to 100 μm, from 15 μm to 80 μm, from 15 μm to 60 μm, from 15 μm to 40 μm, from 20 μm to 160 μm, from 20 μm to 140 μm, from 20 μm to 120 μm, from 20 μm to 100 μm, from 20 μm to 80 μm, from 20 μm to 60 μm, or from 20 μm to 40 μm.

The multilayer structure may further comprise a sealant layer. The sealant layer may generally be heated and pressed to seal two multilayer structures to one another. The sealant layer may be positioned on the oriented film. As described herein, positioned “on” the oriented film means either in direct contact with the oriented film or minimally separated from the oriented film, such as by a tie layer. As described herein, a “tie layer” refers to a polymeric layer which is positioned between and in direct contact with two polymer layers. The tie layer may generally promote adhesion between the two polymer layers it contacts. When no tie layer is present, the sealant layer may be in adhering contact with the oriented film. The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

In one or more embodiments, the sealant layer may be extrusion coated on the oriented film. As described herein, the sealant layer may be extrusion coated on the machine direction oriented polyethylene film by extruding the molten components of the sealant layer through a die onto the film to achieve a desired layer thickness as is known to those having ordinary skill in the art. Extrusion coating may be known generally to those skilled in the art and generally include coating of a molten web of polymeric material onto a substrate material, usually at an elevated temperature. If a tie layer is present, the tie layer may be extrusion coated directly onto the oriented film, and the sealant layer may be extruded onto the tie layer.

According to one or more embodiments, the sealant layer may comprise from 15 to 40 percent by weight of a low density polyethylene based on the total weight of the sealant layer. For example, the sealant layer may comprise from 15 to 20 percent by weight, from 20 to 25 percent by weight, from 25 to 30 percent by weight, from 30 to 35 percent by weight, from 35 to 40 percent by weight, or combinations of any of these ranges, of a low density polyethylene based on the total weight of the sealant layer. In additional embodiments, the sealant layer may comprise from 15 to 30 percent by weight of a low density polyethylene based on the total weight of the sealant layer.

In one or more embodiments, the low density polyethylene of the sealant layer may have a molecular weight distribution (Mw/Mn) of from 7 to 13. For example, the low density polyethylene of the sealant layer may have a molecular weight distribution of from 7 to 8, from 8 to 9, from 9 to 10, from 10 to 11, from 11 to 12, from 12 to 13, or any combination of these ranges. As used herein, Molecular Weight Distribution (MWD) of a polymer is defined as the quotient Mw/Mn, where Mw is a weight average molecular weight of the polymer and Mn is a number average molecular weight of the polymer.

In one or more embodiments, the low density polyethylene of the sealant layer may have a melt index (I₂) of from 1.5 to 9. For example, the low density polyethylene of the sealant layer may have a melt index of from 1.5 to 2, from 2 to 2.5, from 2.5 to 3, from 3 to 3.5, from 3.5 to 4, from 4 to 4.5, from 4.5 to 5, from 5 to 5.5, from 5.5 to 6, from 6 to 6.5, from 6.5 to 7, from 7 to 7.5, from 7.5 to 8, from 8 to 8.5, from 8.5 to 9, or any combination of these ranges. For example, the low density polyethylene of the sealant layer may have a melt index of approximately 2.3. As used herein, melt index (I₂) is a measure of melt flow rate of a polymer as measured by ASTM D1238 at a temperature of 190° C. and a 2.16 kg load.

In one or more embodiments, the low density polyethylene of the sealant layer may be chosen from DOW LDPE 770G (commercially available from The Dow Chemical Company), which has a density of 0.918 g/cm³, a melt index of 2.3 g/10 minutes, and a melting point of 110° C., or AGILITY EC 7220 Performance LDPE (commercially available from The Dow Chemical Company), which has a density of 0.918 g/cm³ and a melt index of 1.5 g/10 minutes. However, other LDPE's are contemplated for use in the sealant layer, and embodiments described herein are not limited to those including these polymers.

In some embodiments, in addition to the low density polyethylene, the sealant layer may comprise a propylene-based plastomer. In one or more embodiments described herein, a “propylene-based plastomer” may refer to a semi-crystalline copolymer of propylene and ethylene that includes greater than 70 wt. % of polypropylene containing semi-crystalline isotactic stereochemistry. The propylene-based plastomer may have a density range of 0.888 g/cc to 0.858 g/cc and/or a glass transition temperature of from −15° C. to −35° C. The propylene-based plastomers described herein include propylene-based copolymers (meaning units derived from two or more comonomers) of propylene with alpha olefin comonomers such as ethylene, butene, pentene, 4-methyl-1-pentene, hexene, heptene, octene, or nonene. Plastomers may generally be understood as polymeric materials which combine qualities of elastomers and plastics.

According to one or more embodiments, the sealant layer may comprise from 60 to 85 percent by weight of a propylene-based plastomer based on the total weight of the sealant layer. For example, the sealant layer may comprise from 60 to 65 percent, from 65 to 70 percent, from 70 to 75 percent, from 75 to 80 percent, from 80 to 85 percent, or any combination of these ranges, by weight of a propylene-based plastomer based on the total weight of the sealant layer.

According to one or more embodiments, the propylene-based plastomer may have a density of 0.890 g/cm³ or less. For example, the propylene-based plastomer may have a density of from 0.860 g/cm³ to 0.890 g/cm³, such as from 0.860 g/cm³ to 0.865 g/cm³, from 0.865 g/cm³ to 0.870 g/cm³, from 0.870 g/cm³ to 0.875 g/cm³, from 0.875 g/cm³ to 0.880 g/cm³, from 0.880 g/cm³ to 0.885 g/cm³, from 0.885 g/cm³ to 0.890 g/cm³, or any combination of these ranges.

In one or more embodiments, the propylene-based plastomer may have a melt flow rate (at 230° C. and 2.16 kg) of at least 5 g/10 minutes. For example, the propylene-based plastomer may have a melt flow rate (at 230° C. and 2.16 kg) of from 5 g/10 minutes to 35 g/10 minutes, such as from 5 g/10 minutes to 10 g/10 minutes, from 10 g/10 minutes to 15 g/10 minutes, from 15 g/10 minutes to 20 g/10 minutes, from 20 g/10 minutes to 25 g/10 minutes, from 25 g/10 minutes to 30 g/10 minutes, from 30 g/10 minutes to 35 g/10 minutes, or any combination of these ranges. As described herein, the melt flow rate is measured in accordance with ASTM D 1238-10, Condition 230° C./2.16 kg, and is reported in grams eluted per 10 minutes.

In one or more embodiments, the propylene-based plastomer may have a melt flow rate of from 20 g/10 minutes to 30 g/10 minutes. For example, the propylene-based plastomer may have a melt flow rate of from 20 g/10 minutes to 22 g/10 minutes, from 22 g/10 minutes to 24 g/10 minutes, from 24 g/10 minutes to 26 g/10 minutes, from 26 g/10 minutes to 28 g/10 minutes, from 28 g/10 minutes to 30 g/10 minutes, or any combination of these ranges. In one or more embodiments, the crystallinity of propylene-based plastomer may be from 12% to 30% and/or the glass transition temperature may be from −15° C. to 35° C.

In one or more embodiments, the propylene-based plastomer may have a melting point of from 60° C. to 120° C. For example, the propylene-based plastomer may have a melting point of from 60° C. to 80° C., from 80° C. to 100° C., from 100° C. to 120° C., or any combination of these ranges.

In one or more embodiments the propylene-based plastomer may be a copolymer comprising units of propylene and ethylene. According to one or more embodiments, the propylene-based plastomer may have an ethylene content of from 2 wt. % to 15 wt. %. For example, the propylene-based plastomer may have an ethylene content of from 2 wt. % to 4 wt. %, from 4 wt. % to 6 wt. %, from 6 wt. % to 8 wt. %, from 8 wt. % to 10 wt. %, from 10 wt. % to 12 wt. %, from 12 wt. % to 15 wt. %, or any combination of these ranges.

In one or more embodiments, the propylene-based plastomer may be VERSIFY 4200 Plastomer (commercially available from The Dow Chemical Company), which has a density of 0.876 g/cm³, melt flow rate of 25 g/10 minutes, and melting point of 100° C. However, other propylene-based plastomers are contemplated for use in the sealant layer, and embodiments described herein are not limited to those including these polymers.

In some embodiments, in addition to the low density polyethylene, the sealant layer may comprise an ethylene-based elastomer. As described herein, an “ethylene-based elastomer” refers to an elastomer that includes greater than 50% by mole of units derived from ethylene monomer. This includes ethylene-based alpha alkene copolymers (meaning units derived from two or more comonomers) with density of 0.870 g/cc to 0.911 g/cc. Elastomers may generally be understood as polymeric materials that exhibit viscoelasticity (i.e., those that exhibit both viscous and elastic characteristics when undergoing deformation).

According to one or more embodiments, the sealant layer may comprise from 60 wt. % to 85 wt. % percent of an ethylene-based elastomer based on the total weight of the sealant layer. For example, the sealant layer may comprise from 60 wt. % to 65 wt. %, from 65 wt. % to 70 wt. %, from 70 wt. % to 75 wt. %, from 75 wt. % to 80 wt. %, from 80 wt. % to 85 wt. %, or any combination of these ranges, of an ethylene-based elastomer based on the total weight of the sealant layer.

In one or more embodiments, the ethylene-based elastomer may have a density of from 0.87 g/cm³ to 0.911 g/cm³. For example, the ethylene-based elastomer may have a density of from 0.87 g/cm³ to 0.875 g/cm³, from 0.875 g/cm³ to 0.88 g/cm³, from 0.88 g/cm³ to 0.885 g/cm³, from 0.885 g/cm³ to 0.90 g/cm³, from 0.90 g/cm³ to 0.905 g/cm³, from 0.905 g/cm³ to 0.911 g/cm³, or any combination of these ranges.

In one or more embodiments, the ethylene-based elastomer may have a melt index of at least 3 g/10 minutes, such as from 3 g/10 minutes to 30 g/10 minutes. For example, the ethylene-based elastomer may have a melt index of from 3 g/10 minutes to 5 g/10 minutes, from 5 g/10 minutes to 7.5 g/10 minutes, from 7.5 g/10 minutes to 10 g/10 minutes, from 10 g/10 minutes to 12.5 g/10 minutes, from 12.5 g/10 minutes to 15 g/10 minutes, from 15 g/10 minutes to 17.5 g/10 minutes, from 17.5 g/10 minutes to 20 g/10 minutes, from 20 g/10 minutes to 22.5 g/10 minutes, from 22.5 g/10 minutes to 25 g/10 minutes, from 25 g/10 minutes to 27.5 g/10 minutes, from 27.5 g/10 minutes to 30 g/10 minutes, or any combination of these ranges.

In one or more embodiments, the ethylene-based elastomer may have a melting point of from 65° C. to 100° C. For example, the ethylene-based elastomer may have a melting point of from 65° C. to 70° C., from 70° C. to 75° C., from 75° C. to 80° C., from 80° C. to 85° C., from 85° C. to 90° C., from 90° C. to 95° C., from 95° C. to 100° C., or any combination of these ranges.

In one or more embodiments, the ethylene-based elastomer of the sealant layer may be chosen from ENGAGE 8401 (commercially available from The Dow Chemical Company), which has a density of 0.885 g/cm³ and a melt index of 30 g/10 minutes, or ENGAGE 8411 (commercially available from The Dow Chemical Company), which has a density of 0.88 g/cm³ and a melt index of 18 g/10 minutes. However, other ethylene-based elastomers are contemplated for use in the sealant layer, and embodiments described herein are not limited to those including these polymers.

In one or more embodiments, the combination of the low density polyethylene and the propylene-based plastomer may comprise at least 90 wt. % of the sealant layer. In additional embodiments, the combination of the low density polyethylene and the propylene-based plastomer may comprise at least 92 wt. %, at least 94 wt. %, at least 96 wt. %, at least 98 wt. %, at least 99 wt. %, at least 99.5 wt. %, or 100 wt. % of the sealant layer.

In one or more embodiments, the combination of the low density polyethylene and the ethylene-based elastomer may comprise at least 90 wt. % of the sealant layer. In additional embodiments, the combination of the low density polyethylene and the ethylene-based elastomer may comprise at least 92 wt. %, at least 94 wt. %, at least 96 wt. %, at least 98 wt. %, at least 99 wt. %, at least 99.5 wt. %, or 100 wt. % of the sealant layer.

As described herein, the multilayer structure may include a tie layer. The tie layer may provide a bond between an oriented polyethylene film and the propylene based plastomer sealant such that it may be positioned in contact with and between the sealant layer and the oriented film. In one or more embodiments, the tie layer may comprise a polyethylene having a density of 0.923 g/cm³ and/or less and a melt index (l2) of at least 4 g/10 minutes. The tie layer may comprise at least 60 wt. % of polyethylene, such as at least 70 wt. %, at least 80 wt. %, at least 90 wt. %, at least 95 wt. %, or even at least 99 wt. % of the polyethylene having a density of 0.923 g/cm³ or less and a melt index (I₂) of at least 4 g/10 minutes. In one or more embodiments, such polyethylene may have a density of 0.923 g/cm³ or less, such as from 0.900 to 0.905, from 0.905 to 0.910, from 0.910 to 0.915, from 0.915 to 0.920, from 0.920 to 0.923, or any combination of these ranges. In one or more embodiments, the tie layer may have a melt index (I₂) of at least 4 g/10 minutes, such as at least 6 g/10 minutes, at least 8 g/10 minutes, at least 10 g/10 minutes, at least 12 g/10 minutes, at least 14 g/10 minutes, at least 16 g/10 minutes, at least 18 g/10 minutes, or even at least 20 g/10 minutes.

According to embodiments described herein, a tie layer may be particularly desirable when the sealant layer includes propylene based plastomers so that good adhesion between the sealant layer and the outer layer of the polyethylene film is achieved. It is contemplated that the tie layer may be desirable in such systems, where propylene and ethylene layers would be in direct contact with one another without the use of a tie layer.

According to additional embodiments, the tie layer may comprise at least 15 wt. % of low density polyethylene based on the total weight of the tie layer. For example, the tie layer may comprise at least 20 wt. %, at least 25 wt. %, at least 30 wt. %, at least 35 wt. %, at least 40 wt. %, at least 45 wt. %, or even at least 50 wt. % of low density polyethylene. The low density polyethylene in the tie layer may have similar or identical characteristics and properties as disclosed with respect to the low density polyethylene of the sealant layer For example, a blend of 70 wt. % ELITE™ 5860 or AFFINITY™ 1451 with 30 wt % of DOW™ LDPE 770G or 7220 may be utilized as a tie layer.

Embodiments of the present disclosure also relate to articles, such as packages, formed from the multilayer structures of the present disclosure. Such packages can be formed from any of the multilayer structures of the present disclosure described herein. Examples of such articles can include flexible packages, pouches, stand-up pouches, and pre-made packages or pouches. Various methods of producing embodiments of articles from the multilayer films disclosed herein would be familiar to one of ordinary skill in the art.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Blend,” “polymer blend,” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

### EXAMPLES

Several examples are provided which are directed to one or more of the embodiments presently disclosed.

Sealant layers were extruded onto kraft paper (60 g/m²). All sealant layers were extruded at 290° C. with an air gap of 250 mm and a die gap of 0.6 mm. Nip-off set was −15 mm. The extrusion setup included a Davis Standard ER-WE-PA, Maschinenfabrik Erkrath Nr. 7237 extrusion coating line with an EBR (edge bead reduction) flat, 1050 [mm] wide slit die, equipped with a feed-block co-extrusion system and extruders that have an output of up to 350 kg/h of polymer. For these evaluations a single slot Feedblock and the largest extruder “A” with an ET Barr 3.5″ double flight compression screw L/D 32 was used. The molten polymer was coated onto the paper or film substrate, and cooled by the chill roll. (Chill roll temperature 15° C.).

Table 1 provides the various sealant layer compositions tested. All polymers tested in the sealant layer and identified in Table 1 are commercially available from The Dow Chemical Co. Reference numbers corresponding to the figures are also provided in Table 1. Table 2 provides information of the polymers of the sealant layers.

TABLE 1
Tested sealant layers

| | | FIGS. |
|---|---|---|
| | | reference |
| Sample | Sealant Layer Composition | number |
| Comparative A | 100% AFFINITY ™ PT 1451G1 | 102 |
| Comparative B | 100% ELITE ™ 5800G | 104 |
| Sample 1 | 70% ENGAGE ™ 8401/30% | 106 |
| | DOW ™ LDPE 770G | |
| Sample 2 | 70% VERSIFY ™ 4200/30% | 108 |
| | DOW ™ LDPE 770G | |
| Comparative C | 70% AFFINITY ™ PT1451G1/ | 110 |
| | DOW ™ 30% PT7007 | |
| Comparative D | 70% ENGAGE ™ 8402/30% | 112 |
| | LDPE 770G | |
| Sample 3 | 70% ENGAGE ™ 8411/30% | 114 |
| | LDPE 770G | |

TABLE 2
Selected properties of materials of tested sealant layers

| | | | DSC |
|---|---|---|---|
| | | | Melting |
| | Melt Index | | Point |
| | g/10 min | Density | Heating rate |
| Material | at 190° C./2.16 kg | g/cm³ | 10° C./min |
| AFFINITY ™ PT | 7.5 | 0.902 | 98 |
| 1451G1 | | | |
| ENGAGE ™ 8401 | 30 | 0.885 | 80 |
| ENGAGE ™ 8411 | 18 | 0.88 | 76 |
| ENGAGE ™ 8402 | 30 | 0.902 | 96 |
| ELITE ™ 5800G | 12 | 0.911 | 103 |
| ELITE ™ 5860 | 22 | 0.908 | 103 |
| VERSIFY ™ 4200 | 25* (at 230 C./2.16 kg) | 0.876 | 84 |
| DOW ™ LDPE 770G | 2.3 | 0.918 | 110 |
| DOW ™ LDPE PT | 7.5 | 0.918 | 106 |
| 7007 | | | |

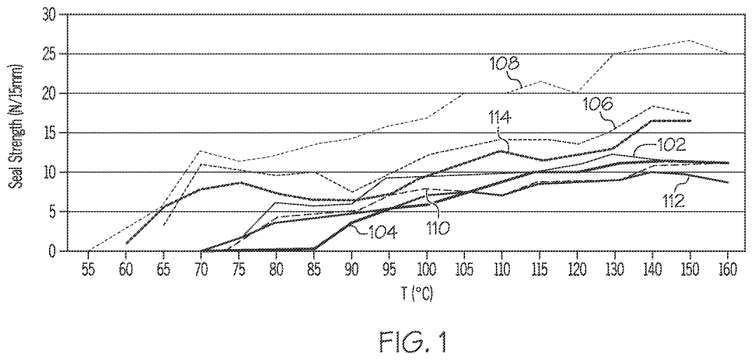

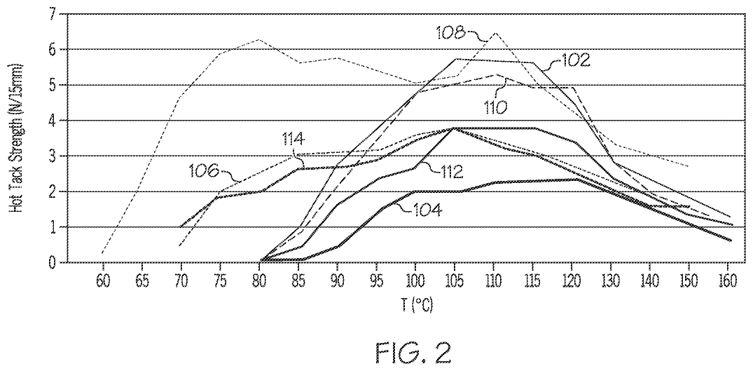

FIG. 1 shows the seal strength in N/15 mm as a function of sealing temperature (° C.). As is depicted, in general, Samples 1-3 had greater seal strength relative to temperature than the comparative examples tested. Additionally, FIG. 2 shows hot tack data, where Samples 1-3 provide better hot tack strength at lower sealing temperatures (e.g., less than 80° C.). It should be noted that Samples 1 and 3 are representative of a sealant layer comprising low density polyethylene and ethylene-based elastomer, as is described in the detailed description. Sample 2 is representative of a sealant layer comprising low density polyethylene and propylene-based plastomer. The increased seal strength and hot tack strength at lower temperatures is desirable, and indicates lower heat seal and hot tack initiation temperatures. Samples 1-3 also had greater overall seal strength at most temperatures than the comparative examples.

Processability of the samples was also analyzed. Table 3 shows neck-in and draw down speeds for the tested samples. Neck-in is the polymer film shrinkage between the die exit and the coating substrate (i.e. during the air gap) and is considered waste of material. Draw down refers to the how fast the coating line can run and how thin the polymer film can be stretched. A good polymer for extrusion coating should have low neck-in (to minimize polymer waste) and high/sufficient draw down (to get a thin coating and high throughput). As is shown, Samples 1-3 have acceptable, and in many cases, superior neck-in and draw down as compared with other sealant materials.

TABLE 3

| | | Neck-in | Neck-in | |
|---|---|---|---|---|
| | | at | at | |
| | | 25 g/m² | 25 g/m² | Draw |
| | | and | and | Down |
| | Sealant Layer | 100 mpm | 300 mpm | Speed |
| Sample | Composition | (mm) | (mm) | (m/min) |
| Comparative A | 100% AFFINITY ™ PT | 290 | 341 | 450 |
| | 1451G1 | | | |
| Comparative B | 100% ELITE ™ 5800G | 168 | 150 | 353 |
| Sample 1 | 70% ENGAGE ™ 8401/ | 153 | 168 | 309 |
| | 30% DOW ™ LDPE | | | |
| | 770G | | | |
| Sample 2 | 70% VERSIFY ™ 4200/ | 146 | 148 | 150 |
| | 30% DOW ™ LDPE | | | |
| | 770G | | | |
| Comparative C | 70% AFFINITY ™ | 158 | 138 | 327 |
| | PT1451G1/30% | | | |
| | DOW ™ LDPE PT7007 | | | |
| Comparative D | 70% ENGAGE ™ 8402/ | 168 | 145 | 400 |
| | 30% DOW ™ LDPE | | | |
| | 770G | | | |
| Sample 3 | 70% ENGAGE ™ 8411/ | 181 | 171 | 400 |
| | 30% DOW ™ LDPE | | | |
| | 770G | | | |

Motor load was also analyzed, as shown in Table 4. Additionally, melt pressure was analyzed and shown in Table 5. Samples 1-3 have acceptable, and in many cases, superior required motor load as compared with other sealant materials. This is a desirable processing feature.

TABLE 4
Motor load

| | | Motor Load | Motor Load | Motor Load |
|---|---|---|---|---|
| | Sealant Layer | (A) 25 g/m², | (A) 25 g/m², | (A) 15 g/m², |
| Sample | Composition | 300 mpm | 100 mpm | 300 mpm |
| Comparative A | 100% AFFINITY ™ PT | 188 | 102 | 71 |
| | 1451G1 | | | |
| Comparative B | 100% ELITE ™ 5800G | 168 | 83 | 59 |
| Sample 1 | 70% ENGAGE ™ 8401/ | 151 | 78 | 55 |
| | 30% DOW ™ LDPE | | | |
| | 770G | | | |
| Sample 2 | 70% VERSIFY ™ 4200/ | 149 | 85 | 65 |
| | 30% DOW ™ LDPE | | | |
| | 770G | | | |
| Comparative C | 70% AFFINITY ™ | 183 | 97 | 71 |
| | PT1451G1/30% | | | |
| | DOW ™ LDPE PT7007 | | | |
| Comparative D | 70% ENGAGE ™ 8402/ | 147 | 73 | 53 |
| | 30% DOW ™ LDPE | | | |
| | 770G | | | |
| Sample 3 | 70% ENGAGE ™ 8411/ | 158 | 84 | 60 |
| | 30% DOW ™ LDPE | | | |
| | 770G | | | |

TABLE 5
Melt Pressure

| | | Melt | Melt | Melt |
|---|---|---|---|---|
| | | Pres- | Pres- | Pres- |
| | | sure | sure | sure |
| | | (bar) | (bar) | (bar) |
| | Sealant Layer | 300 | 100 | 300 |
| Sample | Composition | mpm | mpm | mpm |
| Comparative A | 100% AFFINITY ™ PT | 168 | 87 | 58 |
| | 1451G1 | | | |
| Comparative B | 100% ELITE ™ 5800G | 133 | 54 | 36 |
| Sample 1 | 70% ENGAGE ™ 8401/ | 121 | 53 | 32 |
| | 30% DOW ™ LDPE | | | |
| | 770G | | | |
| Sample 2 | 70% VERSIFY ™ 4200/ | 132 | 71 | 49 |
| | 30% DOW ™ LDPE | | | |
| | 770G | | | |
| Comparative C | 70% AFFINITY ™ | 168 | 81 | 56 |
| | PT1451G1/30% | | | |
| | DOW ™ LDPE PT7007 | | | |
| Comparative D | 70% ENGAGE ™ 8402/ | 119 | 45 | 33 |
| | 30% DOW ™ LDPE | | | |
| | 770G | | | |
| Sample 3 | 70% ENGAGE ™ 8411/ | 132 | 57 | 37 |
| | 30% DOW ™ LDPE | | | |
| | 770G | | | |

Hot tack strength initiation temperature data was gathered, and is shown in Table 6. For these tests, samples were coated with a coating weight of 25 g/m² at 100 m/min line speed and 290° C. extruder set temperature, coated onto paper.

TABLE 5
Hot Tack

| | | Hot Tack |
|---|---|---|
| | | Strength |
| | Sealant Layer | Initiation |
| Sample | Composition | Temperature |
| Comparative A | 100% AFFINITY ™ | 87 |
| | PT1451G1 | |
| Comparative B | 100% ELITE ™ 5800G | 97 |
| Sample 1 | 70% ENGAGE ™ 8401/ | 73 |
| | 30% DOW ™ LDPE | |
| | 770G | |
| Sample 2 | 70% VERSIFY ™ 4200/ | 63 |
| | 30% DOW ™ LDPE | |
| | 770G | |
| Comparative C | 70% AFFINITY ™ | 88 |
| | PT1451G1/30% | |
| | DOW ™ LDPE PT7007 | |
| Comparative D | 70% ENGAGE ™ 8402/ | 89 |
| | 30% DOW ™ LDPE | |
| | 770G | |
| Sample 3 | 70% ENGAGE ™ 8411/ | 73 |
| | 30% DOW ™ LDPE | |
| | 770G | |

### Test Methods

Unless otherwise specified, the following testing methods are utilized to measure the respective properties shown below:

Density

Samples for density measurement were prepared according to ASTM D1928. Polymer samples are pressed at 190° C. and 30,000 psi for three minutes, and then at 21° C. and 207 MPa for one minute. Measurements were made within one hour of sample pressing using ASTM D792, Method B.

Melting Point

Melting Point (Tm) was measured using Differential Scanning Calorimetry (DSC). Differential Scanning Calorimetry (DSC) is measured on a TA Instruments Q1000 DSC equipped with an RCS cooling accessory and an auto sampler. The melting point (Tm) of the samples are measured according to ASTM D3418.

Melt Index

Melt index, or 12, (g/10 min or dg/min) was measured in accordance with ASTM D 1238, Condition 190° C./2.16 kg for polyethylene and 230° C./2.16 kg for polypropylene.

Heat Seal Measurements

Samples were sealed using the Kopp Heat Sealer at a standard temperature range of 60° C.-160° C. The time to seal was set for 0.5 seconds. The set pressure for the heat seal bar was 0.5 N/mm².

Heat seal measurements on the film were performed on a commercial tensile testing machine according to ASTM F-88 (Technique A). Specimens were die cut strips with 15 mm width. The samples were cut along the machine direction; hence, the actual interphases were formed by the fused sealant material in cross-direction. The test result was the force required to pull apart the fused interphase, or the force to break the film in cases where the film breaks before the heat seal interphase separates.

Seal strength is relevant to the opening force and package integrity. Prior to cutting, the films were conditioned for a minimum of 40 hours at 23° C. (+2° C.) and 50% (+5%) R.H. (relative humidity) per ASTM D-618 (procedure A). The seal strength was measured by pulling the fused interphase apart on a Zwick Tensile Tester using a crosshead speed of 100 mm/min.

The heat seal initiation temperature was the minimum sealing temperature required to form a seal of significant strength, in this case 4 N/15 mm. The seal was performed in a Kopp Heat Sealer with 0.5 seconds dwell time at 0.5 N/mm² seal bar pressure. Tensile measurements were conducted on a Zwick Tensile Tester using a crosshead speed of 100 mm/min.

Hot Tack

“Hot tack strength” and like terms mean the strength of heat seals formed between thermoplastic surfaces of flexible webs, immediately after a seal has been made and before it cools to ambient temperature. In form-fill operations, sealed areas of packages are frequently subject to disruptive forces while still hot. If the hot seals have inadequate resistance to these forces, breakage can occur during the packaging process. Hot tack strength was measured with a Hot Tack Tester “J&B” 3000.” Hot tack strength, also known as hot seal strength, is a measure to characterize and rank materials in their ability to perform in commercial applications where this quality is critical. In measurement, the sample is cut into 1 inch strips in the machine direction and tested for a Standard Hot Tack curve from 80°-160° C. in increments of 5° C. until 120° C. and above in increments of 10° C. until 160° C. Teflon coated jaws are standard but metal jaws can be used. Dwell time was 0.5 second and cooling time was 0.2 second. The seal was then pulled apart with a speed of 200 mm/sec and the peel strength recorded.

Hot tack initiation temperature refers to the temperature at which hot tack strength is at least a given threshold strength. For example, in some examples, the hot tack initiation temperature was determined at 1.5 N/15 mm.

Gel Permeation Chromatography (GPC)

The chromatographic system consisted of a PolymerChar GPC-IR (Valencia, Spain) high temperature GPC chromatograph equipped with an internal IR5 infra-red detector (IR5) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 1600 Celsius and the column compartment was set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1)

where M is the molecular weight, A has a value of 0.4315 and B is equal to 1.0.

A fifth order polynomial was used to fit the respective polyethylene-equivalent calibration points. A small adjustment to A (from approximately 0.415 to 0.44) was made to correct for column resolution and band-broadening effects such that NIST standard NBS 1475 is obtained at 52,000 Mw.

The total plate count of the GPC column set was performed with Eicosane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak Max}}{Peak Width at \frac{1}{2} height} )}^{2} \qquad ( EQ2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( EQ3 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 24,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−2% of the nominal flowrate.

Flowrate(effective)=Flowrate(nominal)*(RV(FM Calibrated)/RV(FM Sample)) (EQ7)

The Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn>3) to the narrow standard column calibration results from the narrow standards calibration curve using PolymerChar GPCOne™ Software.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™) should be determined from a linear standard with a molecular weight in excess of about 50,000 g/mole. Other respective moments, Mn_{(Abs)} and Mz_{(Abs)} are be calculated according to equations 8-9 as follows:

$${Mn}_{( Abs )} = \frac{{\sum }^{i} {IR}_{i}}{{\sum }^{i} ( {IR}_{i} / {M}_{{Absolute}_{i}} )} \qquad ( EQ8 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} \qquad ( EQ9 )$$

Extrusion Coating

Monolayer extrusion coatings were performed at a set temperature profiles represented following temperature settings 1: Extruder—200° C./250° C./280° C./290° C./290° C./290° C.; Flange/Adapter/Piping—290° C. (6 zones); and Die—290° C.×10 Zones

The polyethylene and polyropylen resins and blends were extruded on a “3.5 inch” diameter screw, with a length over diameter (L/D) ratio of 32, onto 70 g/m² Kraft paper in an amount (coating weight) of 25 g/m² Melt pressure and melt temperature were recorded with thermocouples placed in the adapter. The melt was delivered through a Davis Standard/Er-We-Pa flex lip edge bead reduction die, Series 510A, nominally set to a die gap of 0.7 mm. The melt drawing and application of the melt vertically onto the moving substrate was performed at an air gap of 250 mm and a nip off-set of 15 mm, towards the pressure roll. The melt was applied onto the moving substrate in the laminator nip, which is the contact point of the pressure roll, with a rubber surface layer contacting the “water cooled” chill roll with a matte surface finish, and maintained at a temperature of 15° C. to 20° C. The air gap is defined as the vertical distance between the die lip and the laminator nip. The nip off-set is defined as the horizontal off-set of the die lip position relative to the laminator nip. For “draw-down” determination, varying (gradually increasing) line speed was used, at a starting coating weight of 15 g/m² and a starting line speed of 100 m/min. “Draw down” is defined as the maximum line speed attainable before web breakage occurs. “Neck-in” is the difference between the final width of the web and the die width at fixed line speed, for example 100 m/min and 300 m/min. Lower “neck-in” and higher “draw down” are both very desirable. Lower “neck-in” indicates better dimensional stability of the web, which, in turn, provides better control of the coating onto the substrate. Higher “draw down” indicates higher line speed, which, in turn, means better productivity.

A first aspect of the present disclosure includes a multilayer structure comprising: an oriented film comprising at least 90% by weight polyethylene; and a sealant layer on the oriented film, wherein the sealant layer comprises: from 15 wt. % to 40 wt. % of a low density polyethylene based on the total weight of the sealant layer; and from 60 wt. % to 85 wt. % of an ethylene-based elastomer based on the total weight of the sealant layer, wherein the ethylene-based elastomer of the sealant layer has a density of from 0.870 g/cm³ to 0.911 g/cm³ and a melt index (I₂) of at least 3 g/10 minutes.

A second aspect of the present disclosure includes a multilayer structure comprising: an oriented film comprising at least 90% by weight polyethylene; and a sealant layer on the oriented film, wherein the sealant layer comprises: from 15 wt. % to 40 wt. % of a low density polyethylene based on the total weight of the sealant layer; and from 60 wt. % to 85 wt. % of a propylene-based plastomer based on the total weight of the sealant layer, wherein the propylene-based plastomer has a density of from 0.890 g/cm³ or less and a melt flow rate (at 230° C. and 2.16 kg) of at least 8 g/10 minutes.

A third aspect of the present disclosure includes any of the previous aspects, wherein the low density polyethylene of the sealant layer has a molecular weight distribution (Mw/Mn) of from 7 to 13.

A fourth aspect of the present disclosure includes any of the previous aspects, wherein the low density polyethylene of the sealant layer has a melt index (I₂) of from 1.5 to 9.

A fifth aspect of the present disclosure includes any of the previous aspects, wherein the oriented film comprises two or more layers.

A sixth aspect of the present disclosure includes any of the previous aspects, wherein the sealant layer is in adhering contact with the oriented film.

A seventh aspect of the present disclosure includes any of the previous aspects, further comprising a tie layer, wherein the tie layer is positioned in contact with and between the sealant layer and the oriented film.

An eighth aspect of the present disclosure includes any of the previous aspects, wherein the tie layer comprises at least 60 wt. % of a polyethylene having a density of 0.923 g/cm³ or less and a melt index (I₂) of at least 4 g/10 minutes.

A ninth aspect of the present disclosure includes any of the previous aspects, wherein the tie layer further comprises at least 15 wt. % of low density polyethylene based on the total weight of the tie layer.

A tenth aspect of the present disclosure includes any of the previous aspects, wherein the ethylene-based elastomer of the sealant layer has a melt index (I₂) of from 3.0 g/10 min to 30 g/10 minutes.

An eleventh aspect of the present disclosure includes any of the previous aspects, wherein the ethylene-based elastomer of the sealant layer has a melting point of from 65° C. to 100° C.

A twelfth aspect of the present disclosure includes the propylene-based plastomer has a melt flow rate (at 230° C. and 2.16 kg) of from 5 g/10 minutes to 35 g/10 minutes.

A thirteenth aspect of the present disclosure includes any of the previous aspects, wherein the propylene-based plastomer is a copolymer comprising units of propylene and ethylene.

A fourteenth aspect of the present disclosure includes any of the previous aspects, wherein the propylene-based plastomer has an ethylene content of from 2 wt. % to 15 wt. %.

A fifteenth aspect of the present disclosure includes any of the previous aspects, wherein the sealant layer is extruded on the oriented film.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component may comprise at least 10%, at least 20%, at least 30%, at least 40%, at least 50%, at least 60%, at least 70%, at least 80%, at least 90%, at least 95%, or even at least 99% that second component (where % can be weight % or molar %).

1. A multilayer structure comprising:
an oriented film comprising at least 90% by weight polyethylene; and
a sealant layer on the oriented film, wherein the sealant layer comprises:
from 15 wt. % to 40 wt. % of a low density polyethylene based on the total weight of the sealant layer; and
from 60 wt. % to 85 wt. % of an ethylene-based elastomer based on the total weight of the sealant layer, wherein the ethylene-based elastomer of the sealant layer has a density of from 0.870 g/cm³ to 0.911 g/cm³ and a melt index (I₂) of at least 3 g/10 minutes.

2. (canceled)

3. The multilayer structure of claim 1, wherein the low density polyethylene of the sealant layer has a molecular weight distribution (Mw/Mn) of from 7 to 13 and has a melt index (I₂) of from 1.5 to 9.

4. (canceled)

5. The multilayer structure of claim 1, wherein the oriented film comprises two or more layers.

6. The multilayer structure of claim 1, wherein the sealant layer is in adhering contact with the oriented film.

7. The multilayer structure of claim 1, further comprising a tie layer, wherein the tie layer is positioned in contact with and between the sealant layer and the oriented film, and wherein the tie layer comprises at least 60 wt. % of a polyethylene having a density of 0.923 g/cm³ or less and a melt index (I₂) of at least 4 g/10 minutes.

8. (canceled)

9. (canceled)

10. The multilayer structure of claim 1, wherein the ethylene-based elastomer of the sealant layer has a melt index (I₂) of from 3.0 g/10 min to 30 g/10 minutes.

11. The multilayer structure of claim 1, wherein the ethylene-based elastomer of the sealant layer has a melting point of from 65° C. to 100° C.

12. (canceled)

13. (canceled)

14. (canceled)

15. The multilayer structure of claim 1, wherein the sealant layer is extruded on the oriented film.

16. A multilayer structure comprising:
an oriented film comprising at least 90% by weight polyethylene; and
a sealant layer on the oriented film, wherein the sealant layer comprises:
from 15 wt. % to 40 wt. % of a low density polyethylene based on the total weight of the sealant layer; and
from 60 wt. % to 85 wt. % of a propylene-based plastomer based on the total weight of the sealant layer, wherein the propylene-based plastomer has a density of from 0.890 g/cm³ or less and a melt flow rate (at 230° C. and 2.16 kg) of at least 8 g/10 minutes.

17. The multilayer structure of claim 16, wherein the low density polyethylene of the sealant layer has a molecular weight distribution (Mw/Mn) of from 7 to 13 and has a melt index (I₂) of from 1.5 to 9.

18. The multilayer structure of claim 16, wherein the sealant layer is in adhering contact with the oriented film.

19. The multilayer structure of claim 16, further comprising a tie layer, wherein the tie layer is positioned in contact with and between the sealant layer and the oriented film, and wherein the tie layer comprises at least 60 wt. % of a polyethylene having a density of 0.923 g/cm³ or less and a melt index (I₂) of at least 4 g/10 minutes.

20. The multilayer structure of claim 16, wherein the propylene-based plastomer has a melt flow rate (at 230° C. and 2.16 kg) of from 5 g/10 minutes to 35 g/10 minutes.

21. The multilayer structure of claim 16, wherein the propylene-based plastomer is a copolymer comprising units of propylene and ethylene.

22. The multilayer structure of claim 21, wherein the propylene-based plastomer has an ethylene content of from 2 wt. % to 15 wt. %.
